(19) United States
(12) Patent Application Publication
(10) Pub. No.: US 2016/0189183 A1
(43) Pub. Date: Jun. 30, 2016

(54) System and method for automatic discovery, annotation and visualization of customer segments and migration characteristics

(71) Applicant: Flytxt BV, Nieuwegein (NL)

(72) Inventors: Shabana KM, Trivandrum (IN); Jobin Wilson, Kothamangalam (IN); Prateek Kapadia, Mumbai (IN); Viju Nambiar, Trivandrum (IN)

(21) Appl. No.: 14/984,697

(22) Filed: Dec. 30, 2015

(30) Foreign Application Priority Data
Dec. 31, 2014 (IN) 6850/CHE/2014

(51) Int. Cl. G06Q 30/02; G06F 17/30

(52) U.S. Cl. CPC G06Q 30/0204; G06F 17/30601

(57) ABSTRACT

System and method for automatic discovery, annotation and visualization of customer segments and migration characteristics. Embodiments herein relate to customer management, and more particularly to segmenting customers based on value and analyzing segment migration of customers. Embodiments herein disclose segmentation of customers performed using value and behavioral attributes with the analyst/marketer providing the bin definitions for each feature or the bin ranges being automatically discovered. Embodiments herein also disclose automatic discovery of the number of segments using frequent pattern mining. Embodiments herein also disclose automatic annotation and visualization of segments that helps in interpreting the segments better. Embodiments herein enable designing of marketing campaigns considering the customer value as well as his behavioral attributes. Embodiments herein analyze segment migration and measure the value impact of migration trends.

### CROSS REFERENCE TO RELATED APPLICATIONS

This application claims the benefit of Indian provisional Application No. 6850/CHE/2014, filed on Dec. 31, 2014, entitled “A system and method for automatic discovery, annotation and interactive visualization of value based customer segments”, the contents of which are incorporated by reference herein

### TECHNICAL FIELD

Embodiments herein relate to customer management, and more particularly to segmenting customers based on value and analyzing segment migration of customers

### BACKGROUND

Segmentation is an important tool used by marketers to divide customers into groups with common behavior characteristics. Segmentation helps in developing customized business strategies to target each of the customer segments based on the specific characteristics exhibited by the group. K-means is one of the most popular clustering technique that works by iteratively refining k clusters to improve the quality of clustering based on some distance function in high-dimensional data-space. However, a major drawback of this technique is the need to specify the value of ‘k’ or the number of clusters in advance by the person.

Annotating results from a clustering algorithm with the most distinguishing feature(s) helps in explaining the high level characteristics of the customers in the cluster. Generating a visual summary of clusters based on cluster sizes, annotations and cluster value can enhance the comprehension of the segments. Interpreting and understanding the results from a clustering algorithm is a tedious process with the person having to manually analyze each of the cluster centroids, variance and other statistical parameters to label the cluster. The person has to manually analyze the feature(s) of each cluster obtained from segmentation and then perform the labeling of each cluster. This becomes tedious when segmentation has to be performed on millions of persons, which can result in a plurality of clusters.

One of the common analysis tasks is to spot and measure the value of prominent behavior trends among customers. However, segmentation fails to capture changes in customer behavior across time, since segmentation is usually performed on a single snapshot of data. Analyzing movement of customers between behavioral segments across different timeframes provide useful insights on prominent migration trends which may be attributed to influence from marketing campaigns or external factors. Analyzing and visualizing migratory trends is difficult because the customer data can have numerous attributes (dimensions).

A current solution performs segment migration analysis using transaction data. However it fails to provide a technique to measure the profitability of various migration trends exhibited by customers across two different time frames.

### BRIEF DESCRIPTION OF FIGURES

Embodiments herein are illustrated in the accompanying drawings, through out which like reference letters indicate corresponding parts in the various figures. The embodiments herein will be better understood from the following description with reference to the drawings, in which:

FIG. 1 depicts a system for performing clustering, annotating and visualizing customer data, according to embodiments as disclosed herein;

FIGS. 2, 3, 4, 5, 6 and 7 depict sample visualizations of segmentation, according to embodiments as disclosed herein;

FIG. 8 is a flowchart depicting the process of segmenting, annotating and creating visualizations of customer data, according to embodiments as disclosed herein;

FIG. 9 is a flowchart depicting the process of performing segment migration analysis, according to embodiments as disclosed herein; and

FIGS. 10, 11, 12, and 13 depict sample visualization of segment migration, according to embodiments as disclosed herein.

### DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Embodiments herein disclose segmentation of customers performed using value and behavioral attributes based on bin definitions for each feature. Embodiments herein also disclose automatic discovery of the number of segments using frequent pattern mining. Embodiments herein also disclose automatic annotation and visualization of segments. Embodiments herein enable designing of marketing campaigns considering the customer value as well as his behavioral attributes. Embodiments herein analyze segment migration and measure value impact of migration trends.

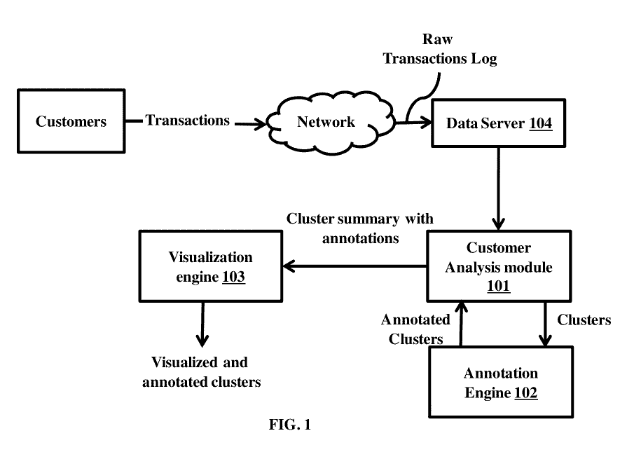

Referring now to the drawings, and more particularly to FIGS. 1 through 13, where similar reference characters denote corresponding features consistently throughout the figures, there are shown preferred embodiments.

Embodiments herein disclose a scalable and automatic system and method for discovery, annotation and interactive visualization of market segments based on customer value and behavioral patterns, and identification and measurement of the value impact of the prominent migration trends of customers across various segments, without having to specify the number of segments in advance.

Embodiments herein disclose a scalable and efficient method to segment customers based on a value attribute and a set of behavioral attributes, wherein customers are first segmented based on a value attribute to create value segments.

Embodiments herein permit binning features into discrete categories, based on the business definitions at hand and perform clustering in each of the value segments based on the behavioral attributes.

Embodiments herein automatically annotate prominent clusters using pre-defined bins for each of the features, thereby making it easier to identify the important characteristics of each cluster.

Embodiments herein interactively visualize the discovered segments using a suitable cluster visualization scheme, wherein the segments can be interactively examined and the distribution of the features in any of the segments can be studied.

Embodiments herein enable designing of marketing campaigns taking into account the customer value as well as his behavioral attributes and readily spot cross sell/upsell opportunities.

Embodiments herein identify and measure the value impact of the prominent migratory trends of customers, when provided with the customer transaction data across two time frames and using the derived insights to identify anomalies in customer behavior, which may result in customer churn, inactivity or change in service preferences.

Embodiments herein segment customers into groups based on their common behavioral attributes. It is often easier to study behaviors at segment level rather than individual, when millions of customers are involved. Customers can also be segmented based on their value to the firm. Ideally, business firms try to promote the profitable behaviors of the high value customers and discourage practices that result in low value to the company. Thus customers can be segmented at least one along two dimensions: based on their value and behavior attributes.

Analyzing movement of customers between behavioral segments across different timeframes provides useful insights on prominent migration trends of customers and helps in identifying anomalous behaviors. Quantifying the value impact of the migration trends can spot profitable trends that can be promoted as well as the non-profitable ones that must be checked.

Embodiments disclosed herein describe the system and methodology using an example of the telecommunications domain, however it can be obvious to a person of ordinary skill in the art to apply embodiments as disclosed herein in the context of customer segmentation and segment migration analysis framework for any domain.

Embodiments herein use the terms ‘user’, and ‘customer’ interchangeably to denote users who are availing of services/products/processes offered by an organization/firm/company.

In a telecom service provider's network, millions of customers generate a lot of usage and transaction data. Segmenting the customers based on their value and then grouping each of the segments based on their behavior trends helps in designing customized marketing campaigns for each group. It also provides opportunities to cross sell/up sell products based on the prominent characteristics of the customers in that segment.

Embodiments herein disclose a scalable, automatic and efficient method to perform segmentation based on value and behavior trends of the customer.

Embodiments herein first segment the customers based on a value attribute that defines the value of a customer. The value attribute can be at least one of Average Revenue per User (ARPU), Average Margin per User (AMPU), minutes of usage and so on. These segments called value segments can be created based on the ranges of value attribute specified by an authorized person such as an administrator, and so on. Each of the value segments can be further segmented based on the behavioral attributes specified by the authorized person. By creating bins based on criteria such as low, medium and high, the attributes can be binned and then segmentation can be performed. Each of the behavioral attributes can be split into a set of bins (automatically or as defined by the authorized person) by using definitions (which can be pre-defined). Segmentation is done using the k-means clustering algorithm after replacing the absolute feature values with the bin values according to the definition. The value of ‘k’, the number of clusters, can be automatically discovered from the data using frequent pattern mining of the discretized dataset. The final segments are automatically annotated based on the distribution of the features across the bins. This makes it easier to identify the important characteristics of each segment. Interactive visualization of the discovered segments can enabled using a suitable means such as a tree-map/doughnut visualization. The segments can be examined interactively and the distribution of the features can be studied in any of the segments.

FIG. 1 depicts a system for performing clustering, annotating and visualizing customer data. The system, as depicted, comprises of a customer analysis module (CAM) 101, an annotation engine 102 and a visualization engine 103. The CAM 101 is connected to at least one data server 104. The data server comprises of a raw log of all customer transactions, performed using the network. The data server 104 can be a dedicated server belonging to the network, an external data storage means, the Cloud, or any other equivalent data storage means. The network can be a telecommunications network, which enables the person to perform at least one transaction using a suitable device. The network can communicate all transactions performed by the person along with a means to uniquely identify the person to the data server 104. The data server 104 can comprise of raw logs from one or more networks. The data server 104 can authorize the CAM 101 to access the data present in the data server 104. The CAM 101 can fetch the data from the data server 104 in at least one of real time, at pre-defined intervals, and at pre-defined events occurring.

The CAM 101 enables an authorized person to select a customer base on which the analysis has to be performed. The CAM 101 can enable the person to select the value attribute based on which value segments are created. The CAM 101 can then fetch data related to the customer base from the data server 104. The CAM 101 can present the person with a histogram that shows the distribution of customers across the value attribute. Using the histogram, the CAM 101 can enable the person to split the value attribute into value ranges and create labels for each of them (for example, using labels such as low, medium, high, and so on). Using the histogram, the CAM 101 can split the value attribute into value ranges and create labels for each of them, based on historical data and/or pre-defined values. The CAM 101 can split the value attribute into value categories such as low, medium, high, etc. This could be performed manually with the help of a histogram or automatically based on the split points discovered by a discretization algorithm, which could be later modified by the person. The CAM 101 can group the customers into value segments based on their value attribute falling in one of the value ranges.

The CAM 101 can select at least one behavior attribute, which can be used for clustering the value segments. For each of the behavior attributes, the CAM 101 can provide the person with the histogram showing the distribution of customers across the attribute. The CAM 101 can split the attributes into intervals and label each of the bin ranges, as was done in the case of the value attribute. This could again be done manually or based on split intervals recommended by a discretization algorithm. The CAM 101 can split the behavior attributes into bins, based on the defined bin ranges. The attribute values are replaced by bin values, which can be based on the number of bins defined for all behavior attributes. The bin values are chosen such that the lowest and highest bin values of all the attributes are the same. In an embodiment herein, the lowest bin value can be 0, followed by powers of 10, such that the binned data set contains only discrete values—zero and powers of 10.

The CAM 101 can cluster each of the value segments separately. The CAM 101 can select the initial cluster seeds. The CAM 101 can discover the most frequent patterns in the data by constructing a pattern matrix by first converting all the bins to zero, except for the bin having the highest value. The CAM 101 can scan the transformed data to identify the unique patterns in the data and their frequency of occurrence. The CAM 101 can add the unique patterns to a pattern matrix. The CAM 101 can sort the pattern matrix in decreasing order based on the frequency of occurrence of the patterns. The CAM 101 can choose the set of most frequent patterns, whose total number of occurrences is at least a fixed threshold of the total number of patterns in the data set, as the initial centroid seeds. The threshold could be determined using at least one of a manual means and by a suitable means such as at least one identified most frequent pattern, statistical significance, pre-defined examples/rules, and so on. Using the initial centroid seeds, the CAM 101 can perform clustering using a suitable clustering algorithm such as k-means along with an appropriate distance measure such as Manhattan distance.

The annotation engine 102 can annotate the final segments. For each cluster and for each attribute in the cluster, the annotation engine 102 can generate the histogram of binned values. Based on the histogram, the annotation engine 102 can identify the bin with the maximum frequency of occurrence and the annotation engine 102 can save the corresponding attribute. Also if the frequency of any bin for any other attribute is greater than a fixed threshold of the total number of customers in the cluster, then the annotation engine 102 can save the corresponding attribute. The threshold could be determined using at least one of a manual means and by a suitable means such as at least one of, statistical significance, pre-defined examples/rules, and so on. For each attribute in the saved list, the annotation engine 102 can generate the annotation by combining the corresponding bin label with the attribute name.

The visualization engine 103 can generate an interactive visualization, which can be in a suitable form such as a tree view/doughnut chart, which summarizes the discovered clusters within each of the value segments. In tree view visualization, the visualization engine 103 can represent the clusters using a suitable shape such as rectangles whose area is proportional to the number of customers in the segment. In an embodiment herein, the shapes can be colour coded based on the average value of the value attribute for the customers in each cluster. The visualization engine 103 can add the cluster annotation to the visualization. The visualization engine 103 can enable the person to select a cluster and view the histograms of the binned attributes of the customers in that particular cluster. The visualization engine 103 can save any of the value segments or clusters in order to run a campaign or to repeat the process of clustering.

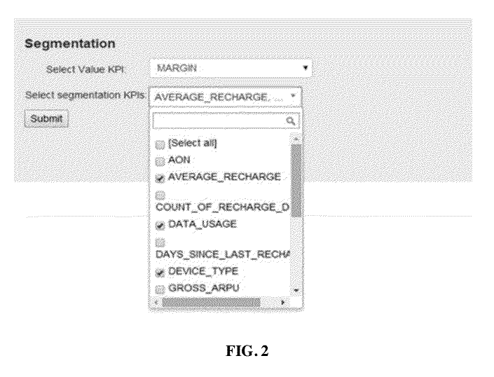

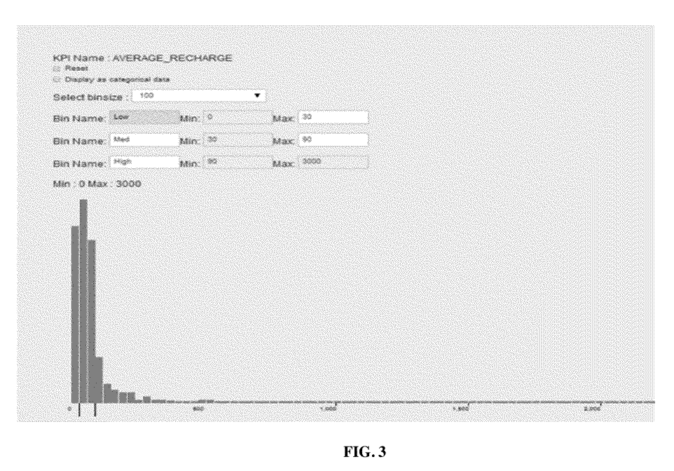

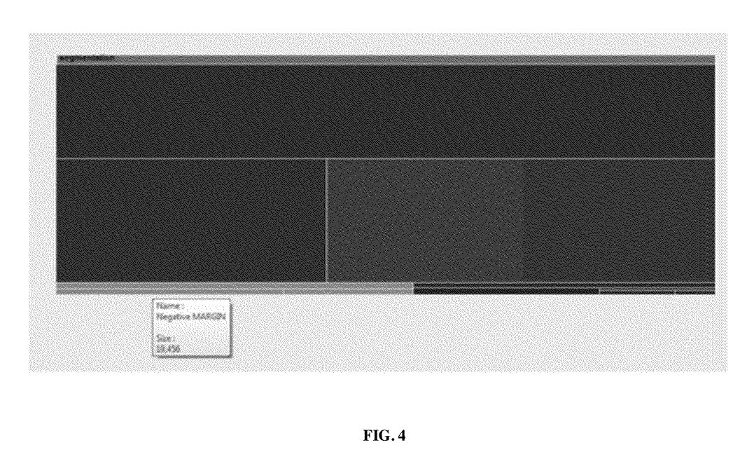

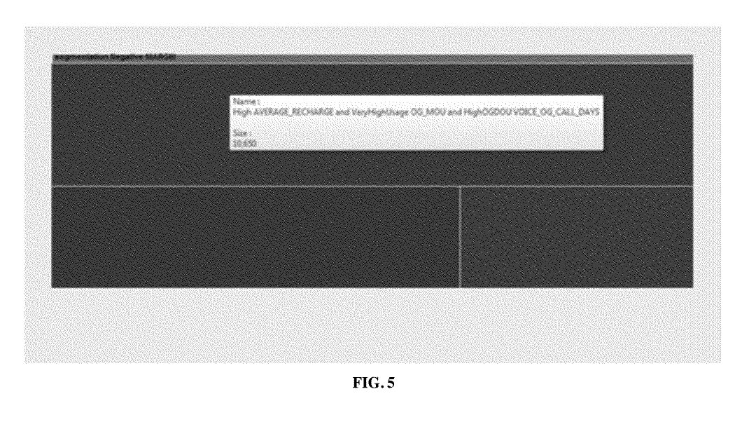

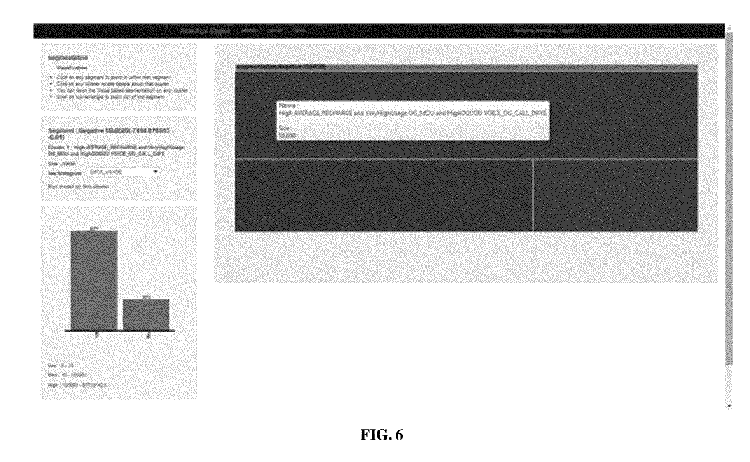

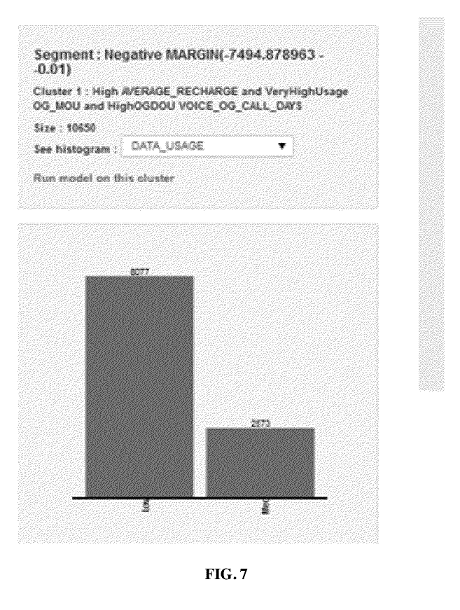

The CAM 101 can enable the person to select the value attribute (Value KPI) and behavior attributes (Segmentation KPIs) (as depicted in FIG. 2). With the help of the histogram showing the distribution of customers across each of the selected KPIs, the CAM 101 can enable the Value KPI and Segmentation KPIs to be split into value ranges and label each of them (low, medium, high, and so on) (as depicted in FIG. 3). In an example, the interactive tree-view visualization generated by the visualization engine 103 after segmentation summarizes the discovered clusters within each of the value segments (as depicted in FIG. 4). In an embodiment herein, a color gradient can be used to represent the average value of the value attribute in each cluster. The visualization engine 103 can display the prominent clusters in a value segment on drill down by clicking on the value segments (as depicted in FIG. 5). By clicking on any of the clusters, the visualization engine 103 can provide the person with the option to view histograms showing the distribution of customers in that cluster across any of the segmentation attributes (as depicted in FIG. 6). The visualization engine 103 can enable the person to save any of the clusters as a new dataset and run the model on the same (as depicted in FIG. 7).

In an embodiment herein, the CAM 101 can enable the person to select data associated with the customer base at two time frames. The CAM 101 can also enable the person to select a value attribute that measures the value impact of the various migration trends. The CAM 101 can enable the person to next select the behavior attributes for segmentation and also define bin ranges for each of them. The CAM 101 can bin and segment the data at the two time frames separately. This is done using the segmentation algorithm as disclosed above. The CAM 101 can compare the cluster membership of customers at the two time frames and uncover the prominent migration trends. The CAM 101 can measure parameters such as average change in the value-attribute and other behavior attributes for the customers before and after migration. The visualization engine 103 can generate an interactive visualization summarizing the results (as disclosed above).

The CAM 101, the annotation engine 102 and the visualization engine 103 comprise of a means to store data, such as at least one of dedicated storage locations, a common storage location, and so on. The storage location can be located remotely from the CAM 101, the annotation engine 102, and the visualization engine 103. The storage location can be co-located with the CAM 101, the annotation engine 102, and the visualization engine 103. Examples of the storage location can be at least one of a cloud, a data server, a network server, a file server, and so on.

The CAM 101, the annotation engine 102, and the visualization engine 103 can comprise of a means to enable the person to view, control and access data. The means can be at least one of a display, a physical interface (such as a keyboard, mouse, touchpad, mouse pad, and so on), a virtual interface, and so on. The means can enable the person access remotely. The means can provide the person with updates remotely, using a suitable mode such as email, SMS (Short Messaging Service), instant messages, and so on.

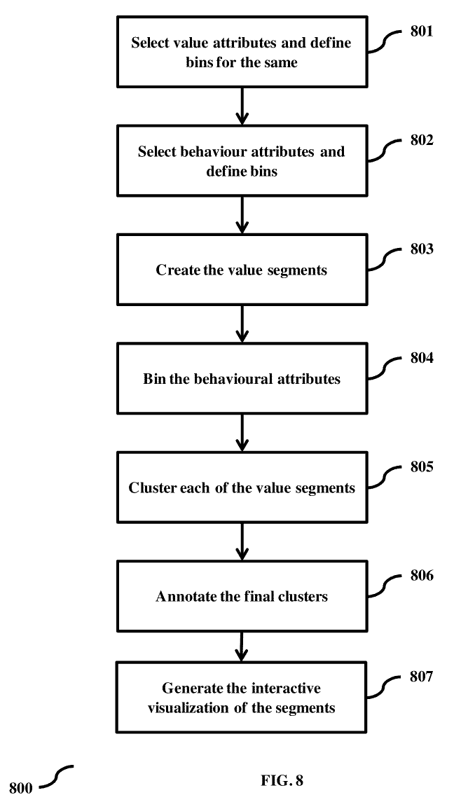

FIG. 8 is a flowchart depicting the process of segmenting, annotating and creating visualizations of customer data. In step 801, a person selects the customer base on which the analysis has to be performed. The person further selects the value attribute based on which value segments are created. The CAM 101 presents the person with a histogram that shows the distribution of customers across the value attribute. With the help of the histogram, the person splits the value attribute into value ranges/segments/bins and labels each of them (for example, using labels such as low, medium, high, and so on). For example, if the person selects Average Revenue per Person (ARPU) as the value attribute, then the bins could be defined as follows:

| | | | |
|---|---|---|---|
| i. | 0-100 | → | Low |
| ii. | 100-200 | → | Medium |
| iii. | 200-400 | → | High |
| iv. | >400 | → | Very High |

In step 802, the behavior attributes are selected, which are used for clustering the value segments. For each of the behavior attributes, the person is provided with the histogram showing the distribution of customers across the attribute. The attributes can be split into intervals and each of the bin ranges are labeled, as was done in the case of the value attribute.

In step 803, the CAM 101 groups the customers into value segments based on their value attribute falling in one of the value ranges defined in step 801. In the given example, four value segments can be formed with customers having ARPU in the specified ranges falling in the corresponding segment.

In step 804, the CAM 101 bins all the behavior attributes based on the bin ranges. The attribute values can be replaced by category values, which are computed based on the number of bins defined for all behavior attributes. The bin values are chosen such that the lowest and highest bin values of all the attributes are the same. The lowest bin value is 0, followed by powers of 10. So the binned data set contains only discrete values—zero and powers of 10.

In step 805, the CAM 101 clusters each of the value segments separately. The initial centroid seeds for clustering are first selected by CAM 101. The most frequent patterns in the data are discovered by constructing a pattern matrix as follows:
Except for the bin having the highest value, the CAM 101 converts all bins to zero. For example, (0, 100, 10000, 1000, 100) is transformed to (0, 0, 10000, 0, 0), where 10000 corresponds to the bin of the highest value.
The CAM 101 scans the transformed data to identify the unique patterns in the data and their frequency of occurrence is also noted. The unique patterns are added to a pattern matrix.
The CAM 101 sorts the pattern matrix in decreasing order based on the frequency of occurrence of the patterns.
The CAM 101 chooses the set of most frequent patterns whose total number of occurrences is at least a fixed threshold of the total number of patterns in the data set as the initial centroid seeds.
   Using the initial centroid seeds, CAM 101 performs clustering using a suitable clustering algorithm such as k-means along with an appropriate distance measure such as Manhattan distance.

Then in step 806, the annotation engine 102 annotates the final segments. For each cluster, the annotation engine 102 performs following steps:
For each attribute in the cluster, the annotation engine 102 generates a histogram of binned values, identifies the bin with the maximum frequency of occurrence and saves the attribute. If the frequency of any bin for any other attribute is greater than a fixed threshold of the total number of customers in the cluster, then the annotation engine 102 saves the attribute.
Now for each attribute in the saved list, the annotation engine 102 combines the corresponding bin label with the attribute name to generate the annotation.

In step 807, the visualization engine 103 generates an interactive visualization, which can be in a suitable form such as a tree view/doughnut chart, which summarizes the discovered clusters within each of the value segments.

The various actions in flow diagram 800 may be performed in the order presented, in a different order or simultaneously. Further, in some embodiments, some actions listed in FIG. 8 may be omitted.

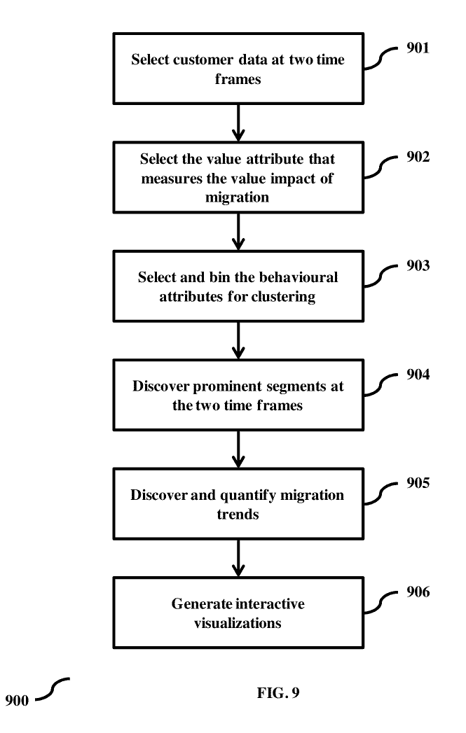

FIG. 9 is a flowchart depicting the process of performing segment migration analysis. In step 901, the CAM 101 enables the person to select the data set associated with a customer base at two time frames, T1 and T2. In step 902, the CAM 101 enables the person to select a value attribute (such as Margin, Average Revenue per User, and so on) that measures the value impact of migration of customers across various behavior segments. In step 903, the CAM 101 enables the person to select the behavior attributes for clustering. The person can also split each of the behavior attributes into value ranges using a discretization algorithm or based on the histograms showing the distribution of customers across the attribute at two time frames, T1 and T2. This is done in similar lines to the bin definition for customer segmentation. In step 904, the CAM 101 replaces the behavior attributes in the two data sets associated with the two time frames with the bin values and segmentation is performed, as is done in the case of customer segmentation framework. The CAM 101 discovers the prominent clusters at the two time frames. The annotation engine 102 performs the cluster annotation for the two sets of clusters. In step 905, the CAM 101 compares the cluster membership of customers at the two time frames and identifies prominent migration trends. The CAM 101 measures the average change in the value attribute and the behavior attributes over migration of customers from one segment to another. In step 906, the visualization engine 103 generates an interactive visualization in the form of a cross tabulation. In an example, the first column lists the customer segments at T1 and the first row lists the customer segments at T2. The cell value Pᵢⱼ represents the percentage of customers belonging to cluster Cᵢ at T1, who have moved to cluster Cⱼ in T2. The average change in the value attribute from T1 to T2, for the customers represented in each cell, is illustrated within the cell using ← (increase), ↓ (decrease) or ⇄ (no change). The visualization engine 103 also enables the person to visualize the change in any of the behavior attributes on migration across any two clusters. The person can save any of the clusters in order to run a campaign.

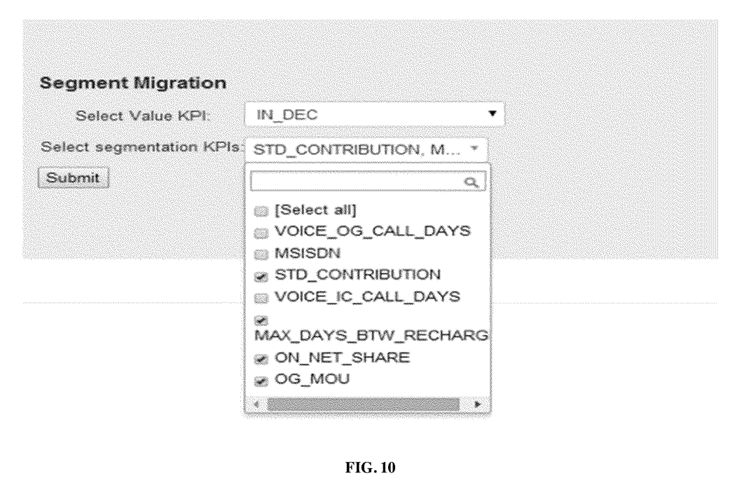

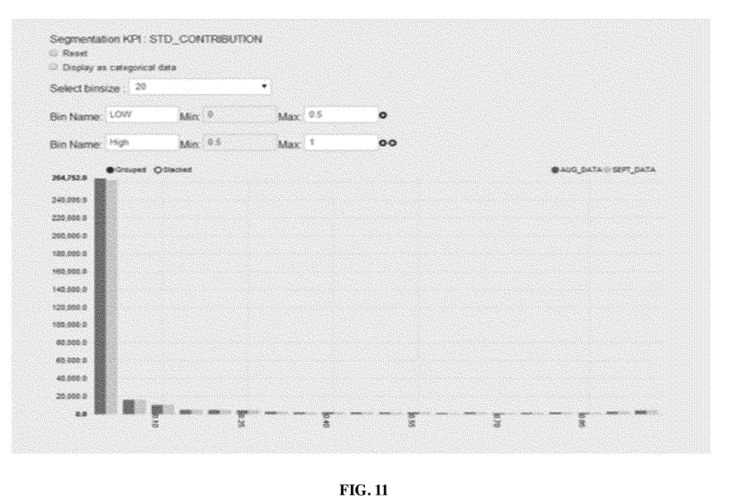

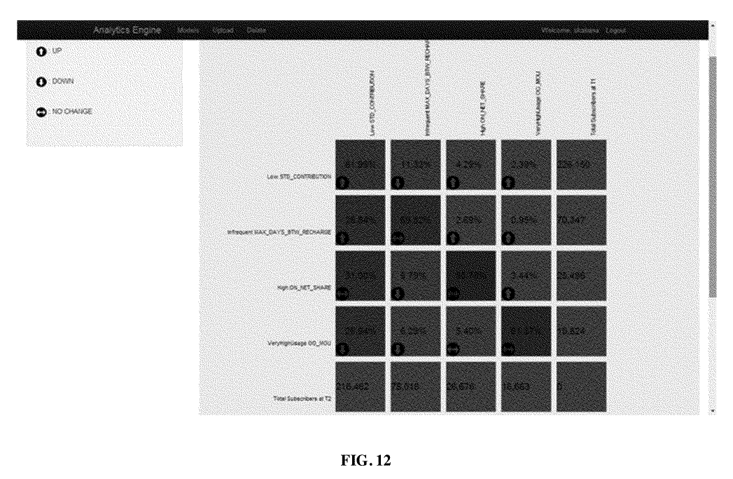

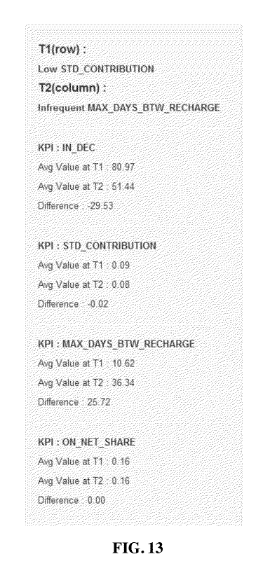

The CAM 101 enables the person to select the Value attribute (Value KPI) and behavioral attributes (Segmentation KPIs) (as depicted in FIG. 10). The bin ranges and the bin labels are defined for each of the Segmentation KPIs with the help of the histograms of the KPIs at the two time frames (as depicted in FIG. 11). The cross tab based visualization that is generated after segment migration analysis shows the prominent migration trends (as depicted in FIG. 12). The Up, Down and No Change arrows represent the average change in Value KPI from T1 to T2 for the customers represented in each cell. On clicking on any of the cells, the average values of Segmentation KPIs at T1 and T2 along with the average change over the time frame are displayed (as depicted in FIG. 13).

The above process is explained considering two time frames merely as an example, the person can select more than two time frames and analysis can be performed by the CAM 101 on the selected time frames and the data can be presented to the user.

The various actions in flow diagram 1000 may be performed in the order presented, in a different order or simultaneously. Further, in some embodiments, some actions listed in FIG. 10 may be omitted.

Embodiments herein enable annotation and visualization of segments thereby enabling better interpretation of the segments. Segment migration analysis enables spotting and quantifying the prominent migration trends of customers between segments at two different time frames and generating a visualization summarizing the analysis.

Embodiments herein disclose scalable and automatic methods and systems for performing segmentation at two levels (value and behavior), performing behavior segmentation using pre-defined bins of features, enabling annotation of segments using the bin definitions provided by the authorized person, visualizing prominent segment characteristics, including segment annotation, number of customers in the segment, segment value, histograms of features in the segment and so on, provisioning to save the segment details for running a marketing campaign or for further segmentation and analyzing the prominent migration trends of customers between segments across two time frames and measure the value of each trend and so on.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for segmentation and annotation of customers based on customer data, customer values and behavioural patterns, the method comprising
grouping customers into at least one value attribute bin by a Customer Analysis Module (CAM) based on at least one value attribute assigned to each customer, wherein the at least one value attribute has been selected and the at least one value attribute bin has been defined;
binning customers into at least one behaviour attribute bin by the CAM based on at least one behaviour attribute of the customer, wherein the at least one behaviour attribute has been selected and the at least one behaviour attribute bin has been defined;
clustering each of the value segments separately by the CAM; and
annotating each of the clustered value segments by an annotation engine.

2. The method, as claimed in claim 1, wherein clustering each of the value segments separately comprises
selecting at least one initial centroid seed by the CAM by discovering most frequent patterns in the customer data and constructing a pattern matrix by the CAM; and
performing clustering by the CAM using the at least one selected centroid seed.

3. The method, as claimed in claim 2, wherein selecting the initial centroid seeds by discovering the most frequent patterns in the customer data and constructing the pattern matrix comprises
converting all bins except a bin with a highest value to zero by the CAM;
scanning the data to identify unique patterns and frequency of occurrence of the unique patterns by the CAM;
adding the identified unique patterns to the pattern matrix by the CAM;
sorting the pattern matrix in decreasing order based on the frequency of occurrence of the unique patterns by the CAM; and
choosing a set of most frequent patterns by the CAM, wherein the chosen set of most frequent patterns comprises of the unique patterns whose total number of occurrences is at least a fixed threshold of total number of patterns in the customer data.

4. The method, as claimed in claim 1, wherein annotating each of the clustered value segments comprises
generating histogram of binned values by the annotation engine, for each attribute in the cluster;
saving an attribute bin with at least one of maximum frequency of occurrence and with frequency of occurrence greater than at least a fixed threshold by the annotation engine; and
generating an annotation by combining a corresponding bin label with the name of the saved attribute by the annotation engine.

5. The method, as claimed in claim 1, wherein the method further comprises generating at least one interactive visualization, wherein the visualization summarizes the clusters within each of the value bins.

6. The method, as claimed in claim 1, wherein the method further comprises
comparing clusters at two time frames to identify migration trends by the CAM;
measuring average change in at least one value attribute and at least one behaviour attribute over migration of customers from one segment to another segment by the CAM.

7. The method, as claimed in claim 6, wherein the method further comprises generating at least one interactive visualization, wherein the visualization summarizes the identified migration trends.

8. A system for segmentation and annotation of customers based on customer data, customer values and behavioural patterns, the system comprising a Customer Analysis Module (CAM), and an annotation engine, the system configured for
grouping customers into at least one value attribute bin by the CAM based on at least one value attribute assigned to each customer, wherein the at least one value attribute has been selected and the at least one value attribute bin has been defined;
binning customers into at least one behaviour attribute bin by the CAM based on at least one behaviour attribute of the customer, wherein the at least one behaviour attribute has been selected and the at least one behaviour attribute bin has been defined;
clustering each of the value segments separately by the CAM; and
annotating each of the clustered value segments by the annotation engine.

9. The system, as claimed in claim 8, wherein the CAM is configured for clustering each of the value segments separately by
selecting at least one initial centroid seed by discovering the most frequent patterns in the customer data and constructing a pattern matrix and
performing clustering using the at least one selected centroid seed.

10. The system, as claimed in claim 9, wherein the CAM is configured for selecting the initial centroid seeds by discovering the most frequent patterns in the customer data and constructing the pattern matrix by
converting all bins except a bin with a highest value to zero;
scanning the data to identify unique patterns and frequency of occurrence of the unique patterns;
adding the identified unique patterns to the pattern matrix;
sorting the pattern matrix in decreasing order based on the frequency of occurrence of the unique patterns; and
choosing a set of most frequent patterns, wherein the chosen set of most frequent patterns comprises of the unique patterns whose total number of occurrences is at least a fixed threshold of total number of patterns in the customer data.

11. The system, as claimed in claim 8, wherein the annotation engine is configured for annotating each of the clustered value segments by
generating histogram of binned values, for each attribute in the cluster;
saving an attribute bin with at least one of maximum frequency of occurrence and with frequency of occurrence greater than at least a fixed threshold; and
generating an annotation by combining a corresponding bin label with the name of the saved attribute.

12. The system, as claimed in claim 8, wherein the system further comprises of a visualization engine, wherein the visualization engine is further configured for generating at least one interactive visualization, wherein the visualization summarizes the clusters within each of the value bins.

13. The system, as claimed in claim 8, wherein the CAM is further configured for
comparing clusters at two time frames to identify migration trends;
measuring average change in at least one value attribute and at least one behaviour attribute over migration of customers from one segment to another segment.

14. The system, as claimed in claim 13, wherein the system further comprises of the visualization engine, wherein the visualization engine is further configured for generating at least one interactive visualization, wherein the visualization summarizes the identified migration trends.
